(19) United States
(12) Patent Application Publication
(10) Pub. No.: US 2018/0053230 A1
(43) Pub. Date: Feb. 22, 2018

(54) COMPOSITE CAPABILITIES CATALOG FOR DESIGN, PUBLISHING AND SUPPORT OF DIGITAL OFFERS

(71) Applicant: Optilus, Inc., Montara, CA (US)

(72) Inventor: Brian Pawlus, Montara, CA (US)

(73) Assignee: Optilus, Inc., Montara, CA (US)

(21) Appl. No.: 15/243,759

(22) Filed: Aug. 22, 2016

(51) Int. Cl. G06Q 30/06; G06Q 30/02

(52) U.S. Cl. CPC G06Q 30/0611; G06Q 30/0201

(57) ABSTRACT

A catalog of capabilities is created with a composite subset or superset of capabilities of a plurality of backend systems. The created capabilities may be used to create, test and launch a plurality of packaged capabilities that affect the customer experience, termed offers, published to a plurality of systems and customers through various marketing channels. Whereas the underlying backend systems' constituent capabilities are defined in different applications by means of different syntaxes and data models, the present technology discovers, learns, and translates the capabilities of systems of interest into a single syntax and data model within a single application and uses the composite capabilities as configurable metadata and building blocks to provide a focal product design environment for users in various domains (e.g., Marketing, IT, Network). Once designed and tested, the products are then published to participating systems and to specified segments of customers through specified marketing channels.

### BACKGROUND

Digital commerce is not only expanding the reach of businesses to a much larger and diverse customer base, but it is also providing customers with diversity of choice between service providers, services, and products. Rapid offer innovation, personalization and proactive measures in meeting customer needs and expectations are paramount to the success of any enterprise conducting commerce digitally. A key impediment to designing components affecting customer experience into digital offers is the legacy characteristics of the infrastructure, in particular the business and operational support systems (BSS/OSS) and network elements that support offer creation, launch, provisioning, quality of service (QoS), customer support, and billing/charging.

The infrastructure in essence is designed and operated by technology specialists. Specifically, the disparate and technical nature of the infrastructure components, integration patterns, intra-system communications, and user interfaces are not conducive to enabling business professionals without a technical background to produce relevant and personalized digital products and services to their customer base. Further, the disparate collection of technical systems employed in designing a single product is typically built by multiple different vendors, based on specific technology and syntax, resulting in no cooperation or communication capability between multiple systems.

### SUMMARY

The present technology may create a catalog of capabilities that are a composite subset or superset of capabilities of a plurality of backend systems. The created capabilities may be used to create, test and launch a plurality of packaged capabilities offered to a plurality of systems and customers through various marketing channels. Whereas the underlying backend systems' constituent capabilities are defined in different applications by means of different syntaxes and data models, the present technology discovers, learns, and translates the capabilities of systems of interest into a single syntax and data model within a single application and uses the composite capabilities as configurable metadata and building blocks to provide a focal offer design environment for users in various domains (e.g., Marketing, IT, Network). The design environment enables the user to embody capabilities into the offer that effectively designs the customer experience. Once designed and tested, the offers are then published to participating systems and to specified segments of customers through specified marketing channels.

An embodiment may include a method for creating an offer based on a reference capability catalog. The method may define by a server a capabilities catalog based on a plurality of identified capabilities of one or more third party providers remote from the server. In response to user input received through an interface provided by the server, an offer may be created which is based on a selected one or more of the capabilities in the catalog. The server may provide the offer to a user over a network.

An embodiment may include a system for creating an offer based on a reference capability catalog. The system may include a server, memory and a processor. One or more modules stored in the memory and executed by the processor to define by the server a capabilities catalog based on a plurality of identified capabilities of one or more third party providers remote from the server. The one or more modules may also be executable to create, in response to user input received through an interface provided by the server, an offer based on a selected one or more of the capabilities in the catalog. The one or more modules may also be executable to provide by the server the offer to a user over a network.

### BRIEF DESCRIPTION OF THE DRAWINGS

FIG. 1 is a block diagram of a system for creating an offer based on a reference capability catalog.

FIG. 2 is a block diagram of a server.

FIG. 3 is a method for creating an offer based on a reference capability catalog.

FIG. 4 is a method for defining a capability catalog.

FIG. 5 is a method of creating a requirements definition project for the creation of an offer.

FIG. 6 is a method for creating an offer based on selected catalog capabilities.

FIG. 7 is a method for designing and offer based on a reference capability catalog.

FIG. 8 is a method for performing validation of an offer design.

FIG. 9 is a method for performing testing of an offer design.

FIG. 10 is a method for providing an offer to a user.

FIG. 11 is a block diagram of the logical flow for creating an offer.

FIG. 12 is a block diagram of a computing system for implementing the present technology.

### DETAILED DESCRIPTION

The present technology relates to the field of digital commerce where businesses and individuals are engaged in selling, buying and trading goods (physical as well as virtual) and services by necessarily employing digital means of ordering, inventory management, charging and fulfillment. Conventionally, the entities involved in conducting digital commerce may include telecommunications service providers, cloud service providers, media service providers, etc. The Internet and other high speed data networks have enabled businesses of many categories to conduct digital commerce, including gaming, insurance, and M2M (machine-to-machine) providers to name a few. Business processes that encompass digital commerce to deliver specific business objectives include concept-to-launch, quote-to-cash, order-to-cash and concept-to-cash-to-care. These processes along with computing networks, the Internet, and various other communication networks, including mobile, broadband and WiFi—collectively referred to as the “infrastructure”—enable the flow of digital commerce.

The present technology may create a catalog of capabilities that are a composite subset or superset of capabilities of a plurality of backend systems. The created capabilities may be used to create, test and launch a plurality of packaged capabilities, heretofore referred to as an offer, and published to a plurality of systems and customers through various marketing channels. Whereas the underlying backend systems' constituent capabilities are defined in different applications by means of different syntaxes and data models, the present technology discovers, learns, and translates the capabilities of systems of interest into a single syntax and data model within a single application and uses the composite capabilities as configurable metadata and building blocks to provide a focal offer design environment for users in various domains (e.g., Marketing, IT, Network). The design environment enables the user to embody capabilities into the offer that effectively designs the customer experience. Once designed and tested, the offers are then published to participating systems and to specified segments of customers through specified marketing channels.

The present technology is designed to create a single offer design environment through an application running in a “cloud” (i.e., over a network) computing environment for digital service providers, used by both technology-driven professionals, such as IT personnel, and business professionals. The design application provides a set of graphical user interfaces (GUIs), a single grammar and single data model to create a reference capabilities catalog. The reference capability catalog is a composite catalog of the capabilities of the underlying computer and network applications and functions. Through one or more GUIs, users of the present technology would manipulate the objects within the reference capabilities catalog to design offers for the market. The resulting offer is unique with respect to this invention in that the embodied capabilities incorporate aspects that affect the customer experience, i.e., customer experience is designed into the offer. Because of the single capabilities catalog, users of the present technology would not need to design components of an offer in each underlying system or use complex methods to orchestrate the assembly of such offers. Rather, users of the present technology design offers in a single environment and expose, or publish, the offers to consuming systems.

The reference capabilities catalog data model may adhere to widely accepted industry and regulatory standards, such as the Telemanagement Forum's Frameworx in terms of capability and data model, Sarbanes-Oxley in terms of standards for fiduciary accountability, PCI-DSS (Payment Card Industry Data Security Standards) when dealing with payment and charging capabilities, and 3GPP when dealing with certain network and IT systems' capabilities. The reference catalog is extensible in that new common capabilities may be identified at a later time.

In some instances, a system subscribing to the capabilities catalog may use it or the information therein as input or trigger to meet its own (i.e., the system's) obligations within a certain business process flow. A system in such instances will require a decomposition of the design elements of the capabilities catalog. To that end, the present technology may provide a reverse translation and decomposition function that provides catalog information to the system in question in terms of the system's own syntax, capabilities, and data model. This function is not the reverse of the aforementioned functionality that was described as providing a mapping and translation mechanism from an external system to the application during initial deployment or as “one-off” events. The capability covered in this objective is an application run-time function with on-demand decomposition, translation, and push notification regarding capabilities. This function serves as a primary mechanism to close the loop with all systems involved in fulfilling an offer and to notify such systems that one or more of their capabilities were launched as part of a composite capability or offer. The systems will then be able to handle requests for exposed capabilities as part of their own run-time processes.

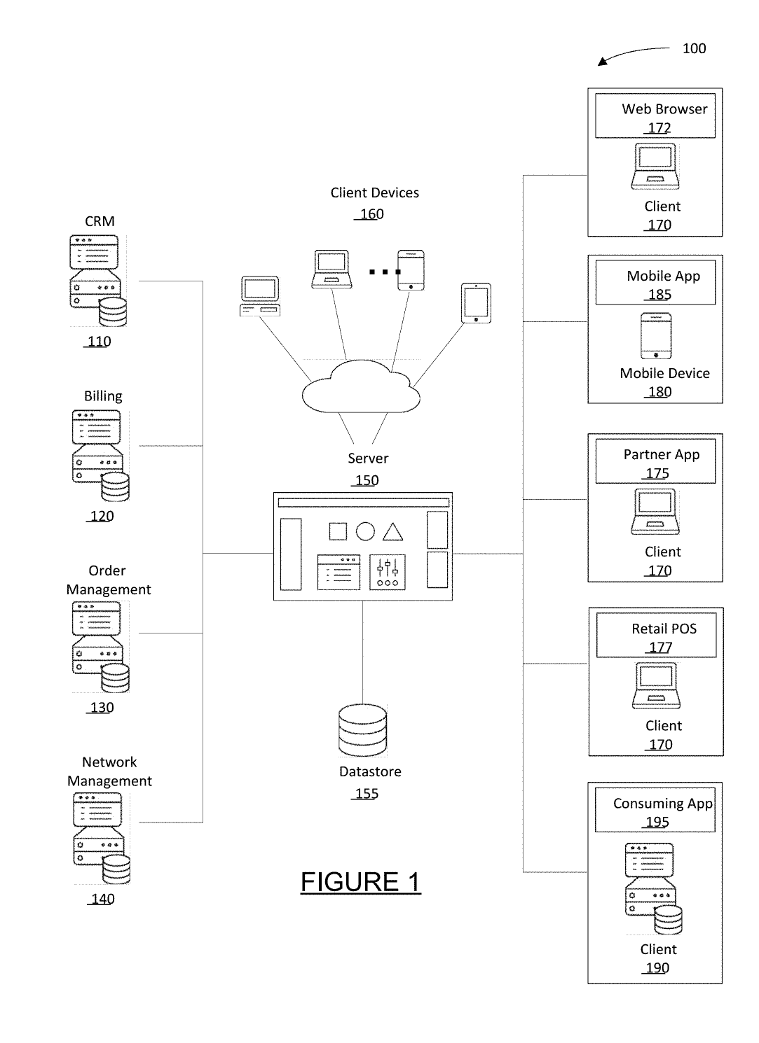

FIG. 1 is a block diagram of a system for creating an offer based on a reference capability catalog. The exemplary system of FIG. 1 includes CRM system 110, billing system 120, order management system 130 and network management system 140 (collectively “contributing systems”), a server 150, datastore 155, and client devices 160. FIG. 1 also includes consuming systems and channels including clients 170, mobile devices 180 and client apps 190.

The contributing systems 110-140 may include third parties that provide services. The third-party services are each associated with a data model. The depicted systems illustrated in FIG. 1 are examples of the most frequently encountered systems, but are not intended to be limiting and are only a subset of systems that can interface to the server 150.

The server 150 in FIG. 1 may include one or more programs, modules or applications that may create reference capability catalogs, create an offer based on a reference capability catalog, and publish the offer. To create the reference capability catalog, the present technology accesses the data module of the contributing systems and converts the data model to a proprietary data model. From the proprietary data model, one or more reference capability catalogs may be generated. Reference catalogs may be accessed through a user interface within the server 150 in order to create an offer.

The completed offer may be provided over a network, for example through a network browser 175 on client 170, mobile app 185 on mobile device 180, and client application 195 on client 190. Servers 150 may perform other functionality as described herein.

One or more users, such as business professionals or technology professionals, may access the server 150 from client devices 160 to perform all or part of reference capability catalog creation and modification, create an offer based on a reference capability catalog, and publish the offer. Server 150 may provide one or more user interfaces to client devices 160 to design and publish the offers, and may store data associated with an offer, data map, reference capability catalog, and other data at datastore 155.

Optilus introduces the concept of “contributing” and “consuming” systems. That is, some systems contribute capabilities to the Optilus platform, while others consume the capabilities designed within the Optilus platform. And some systems can be both consuming and contributing systems. The systems discussed with reference to FIG. 1 are merely exemplary.

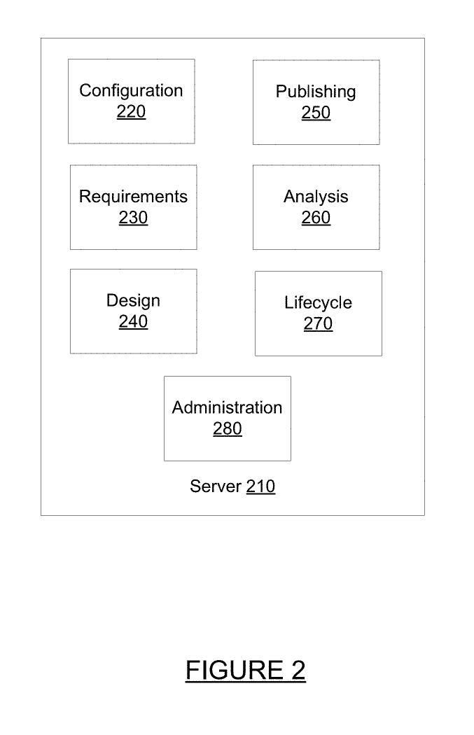

FIG. 2 is a block diagram of an exemplary server. The server 210 of FIG. 2 may provide more detail for a particular server or servers 150 of the system of FIG. 1. Server 210 may include one or more modules which are stored in memory and executed by a processor to perform functionality discussed herein, including create a reference capability catalog, create offer requirements, design an offer, launch or publish the offer to one or more users over a network or channel, and analyze effectiveness of offers. In some instances, server 210 may include a configuration module 220, requirements definition module 230, design module 240, publishing module 250, analysis module 260, offer lifecycle management module 270, and user administration manager 280.

Configuration module 220 may access data models from remote third-party services. The accessed data models may be mapped by module 220 to one or more data objects in a new data model stored locally to or accessibly by the server. Once the mapping is complete, module 220 may generate reference capability catalogs based on the data models and objects.

Requirements module 230 may manage the process of documenting requirements definitions for future offers and tracking the effectiveness of those requirements as they relate to published offers. Input to manage requirements effectiveness may be generated at least in part from the analysis module 260.

Design module 240 may manage the process of designing an offer. The design process may provide atomic and composite capabilities to a user through a graphical user interface. The capabilities may be incorporated into a workspace and associated or connected together to interact with each other. The one or more capabilities may be manipulated and connected through a user interface provided to the user.

Publishing module 250 may perform several steps before publishing of an offer, including validation of an offer and testing of an offer created by a user. Validation may include analyzing capabilities incorporated to the offer as well as relationships between those capabilities to ensure they comply with compatibility rules, exclusions, eligibility rules, and product dependencies.

Publishing module 250 may test an offer that has been validated. In some instances, testing may be automatically performed or may be triggered by an administrator to perform testing of the offer. The testing process may include testing constituent elements of an offer for provider and exposure functionality, testing connections and related capabilities, and modifying or updating a reference capability catalog based on deficiencies in a particular capability.

Publishing module 250 may publish a validated and tested offer to one or more users. Publishing may include pushing the defined offer to users on a particular platform, such as a mobile device or web service, as well as informing third-party service providers that an offer may be using their services.

Analytics module 260 may provide analytics of an offer that is been published. The analytics may include number of sales, revenue generated by the offer, number of service calls, and other metrics associated with the use and sale of a particular offer.

Lifecycle module 270 may perform lifecycle management responsibilities for offers, capabilities, data objects and projects, including status, such as active, archived, obsolete, and so forth.

Several of the modules 220-270 of server 210 may involve a user interface with role-based permissions for receiving or outputting data to a user. Administration manager 280 may configure a user interface provided to a user based on the functionality of a particular module and the role and responsibility of the user. For example, Administration manager 280 may provide a specific design interface to a product manager to implement the design functionality of design module 230. Administration manager 280 may provide a specific publishing interface to a supervisor to implement publishing functions of publishing module 260.

Though a number of modules are illustrated in server 210, more or fewer modules may be implemented by the present technology. For example, each module may be implemented by one or more applications, an application may implement several of the modules, and any number of modules may be implemented on any server of servers 140 of FIG. 1 (i.e., server 210 of FIG. 2). The modules illustrated in FIG. 2 are intended to illustrate an exemplary logical implementation of the functionality described herein, and variations of the actual module organization and implementation are considered within the scope of the present technology.

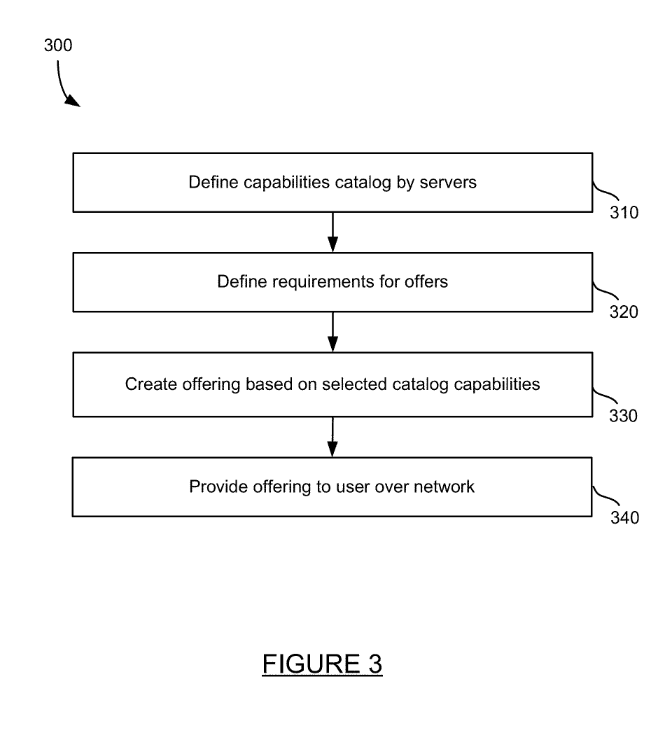

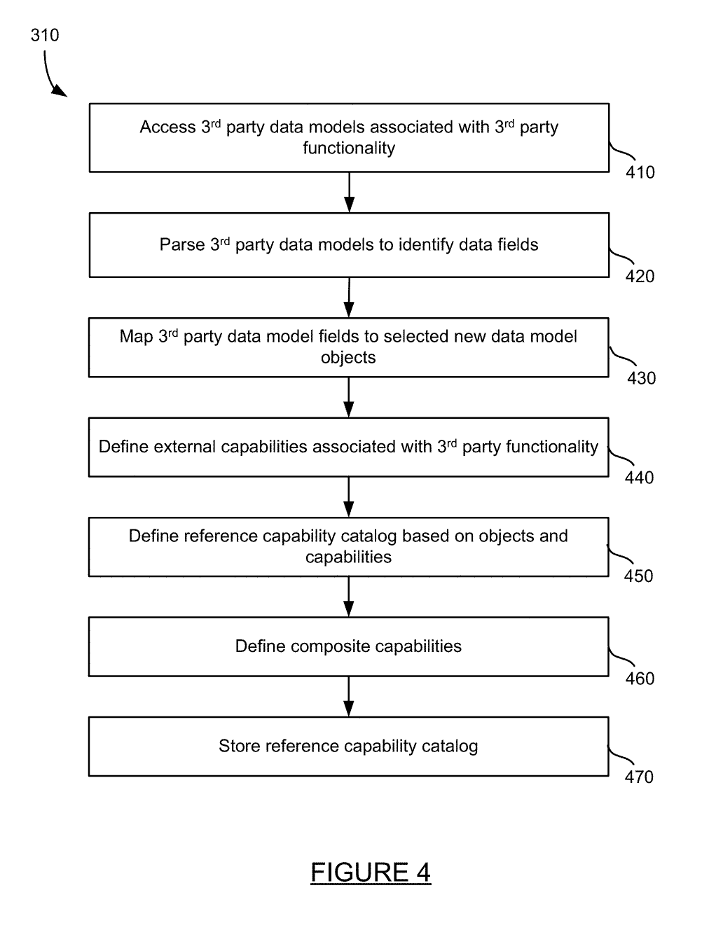

FIG. 3 is a method for creating an offer based on a reference capability catalog. First, the capabilities catalog is defined by one or more servers at step 310. The capabilities catalog may be defined by one or more applications or modules executing on servers based on a data model created from third-party data models. The capabilities catalog may then be used to create an offer. More detail for defining capability catalogs is discussed with respect to the method of FIG. 4.

A project is opened and requirements for an offer are defined in the project in step 320 through the user interface defined in the requirements module 230.

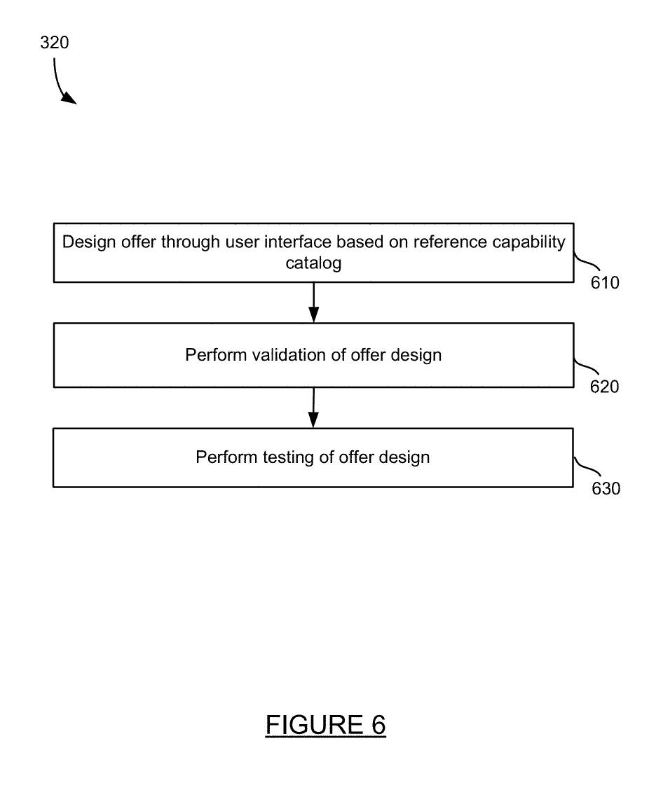

An offer is created based on the selected capabilities at step 330. The selected capabilities are determined based upon requirements defined in step 320. In some instances, design module 240 may provide one or more capabilities within a user interface from which an offer may be created. The offer may include one or more capabilities that are grouped together to form a composite capability or individual atomic capabilities. Once a design is completed, the design may be validated and tested before it is released to users for use. More details for creating an offer based on selected catalog capabilities is discussed in more detail below with respect to the method of FIG. 6.

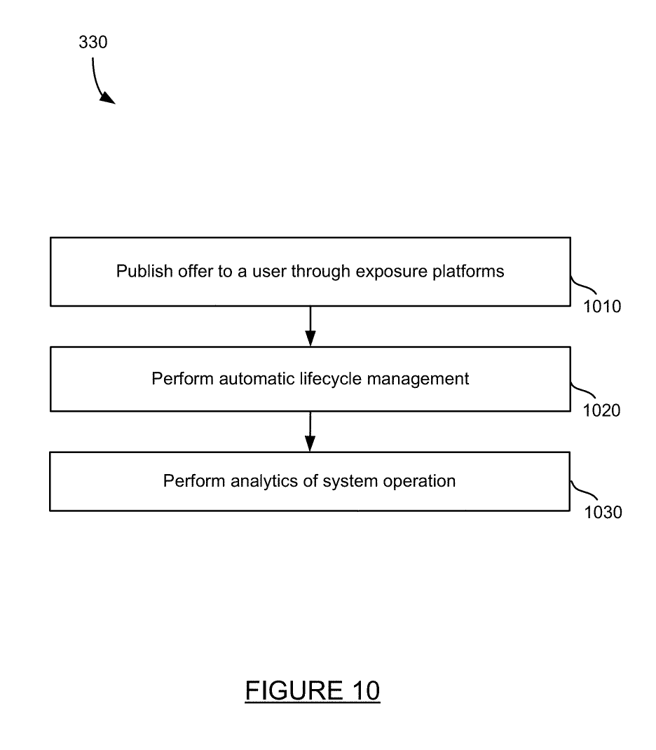

The offer is provided to a user over a network at step 340. The offer may be provided to a user at a mobile device, computing device with a network browser, or some other device. Providing an offer to a user may include publishing the offer, performing lifecycle management, and analytics for the offer. Providing an offer to a user is discussed in more detail below with respect to the method of FIG. 10.

FIG. 4 is a method for defining a capability catalog. The method of FIG. 4 provides more detail for step 310 of the method of FIG. 3. First, third-party data models associated with a third-party functionality are accessed at step 410. Third-party data modules may be accessed by configuration module 220. The data modules may indicate data fields, interface parameters, and other data for communicating with a third-party service. The third-party data models are parsed to identify data fields at step 420. Each data model will likely include multiple data fields, each of which may be identified during a parsing of the data model. The third-party data model fields are mapped to selected new data model objects at step 430. In some instances, configuration module 220 may have access to a plurality of data model object templates. A particular template may relate to a particular type of service, such as a billing service or a sales service. A template may include one or more fields that may be mapped to the third-party data model fields.

External capabilities may be defined which are associated with third-party functionality at step 440. External capabilities may include fields, an application of a field, or some other object. A capability may include an object used to fulfill a process partially or fully. For example, a capability of an “offer presentation” may include product objects, channel information, and system information.

A reference capability catalog is defined at step 450. The reference capability catalog may be based on the new data model objects which are mapped from the third-party data model fields as well as the defined external capabilities. The reference capability catalog is stored, for example in data store 150. Composite capabilities may be defined at step 460. Composite capabilities may be formed from one or more capabilities that make up the reference capability catalog. A reference capability catalog is then stored at step 470. The reference capability catalog may be stored locally at one or more of servers 150, remotely to data store 155, or some other location accessible the servers 150.

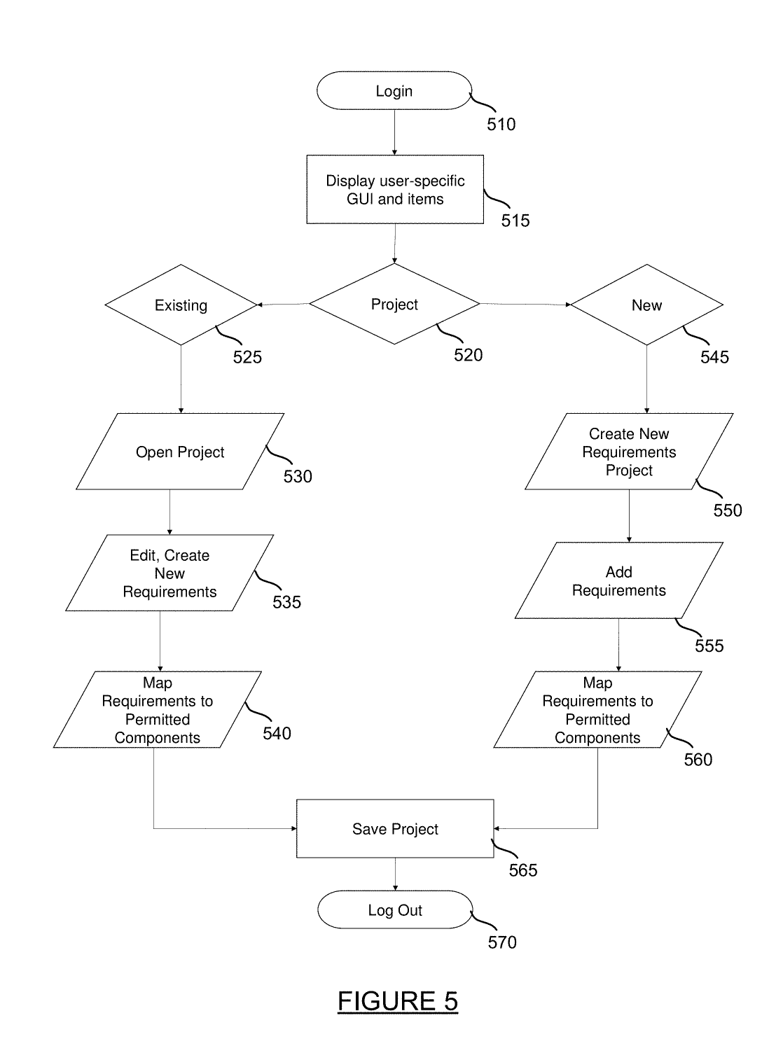

FIG. 5 is a method for creating requirements for the new offer through the creation and modification of a project. The project is the input to the offer design module 250. First, a user logs into the requirements module 230 at step 510, and a GUI with the proper role-base items are displayed to the user at step 515. A new project is created at step 545, or an existing project is opened at step 525. For an existing project, the project is opened at step 530, the requirements are edited or created at step 535, and requirements are mapped to permitted components at step 540. The project may be saved at step 565. For a new project, a new requirement project is created at step 550 and requirements are added at step 555. The requirements may be mapped to permitted components at step 560, and the project may be saved at step 565. A user may logout at step 570.

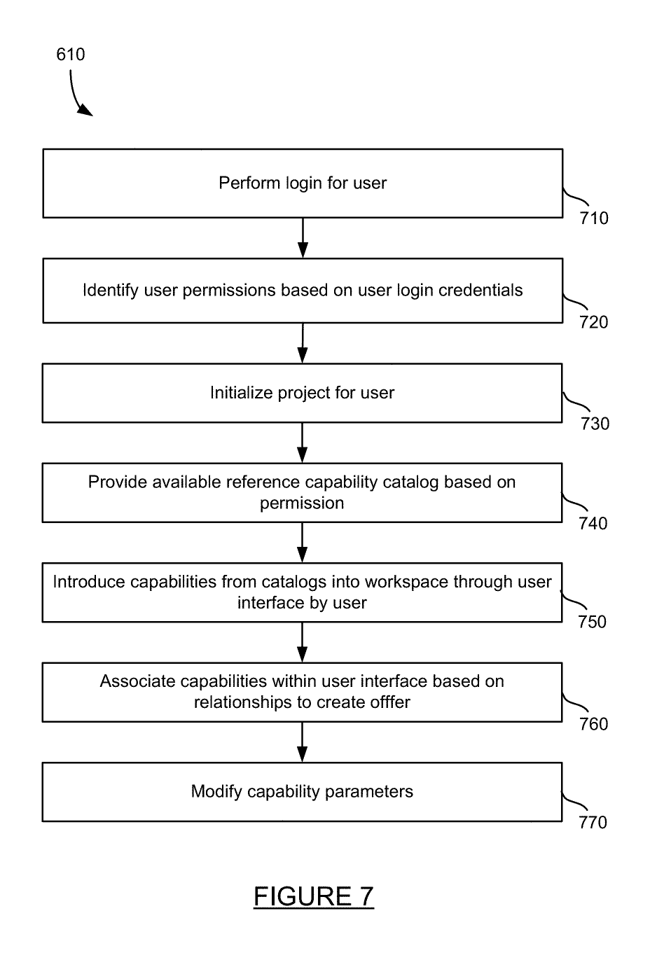

FIG. 6 is a method for creating an offer based on selected catalog capabilities. The method of FIG. 6 provides more detail of step 320 of the method of FIG. 3. First, an offer is designed through a user interface based on reference capability catalog information at step 610. Designing an offer may be performed by user through an interface provided by servers 140. The design functionality may be managed by design module 240 while the interface may be provided by Administration manager 280. Designing an offer may include selecting and modifying reference capabilities within the interface. More details for designing and offer is discussed with respect to the method of FIG. 7.

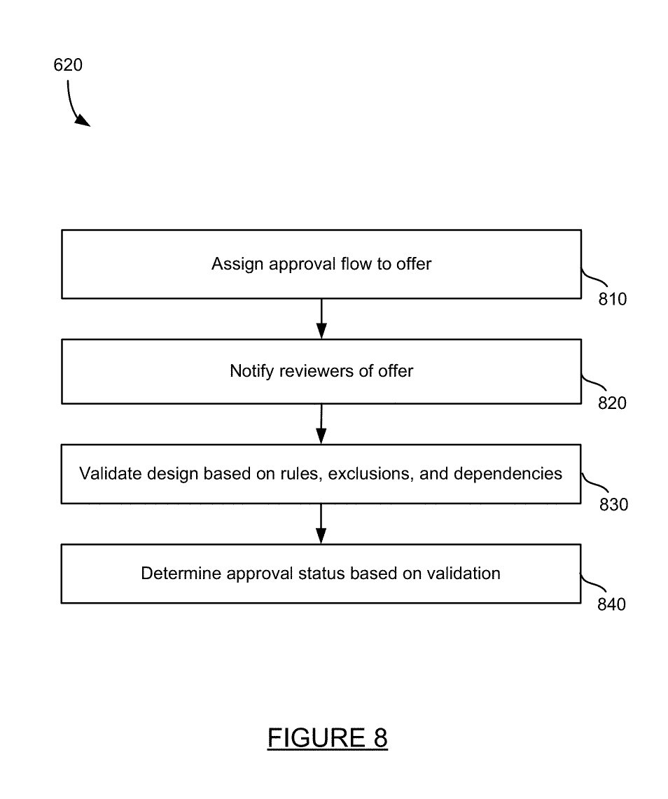

Validation is performed of the designed offer at step 620. A validation may be performed by one or more reviewers of the created offer. In some instances, validation may include a review of the offer based on rules, exclusions, and dependencies associated with individual capabilities used to create the offer. More detail for performing validation of an offer design is discussed with respect to the method of FIG. 8.

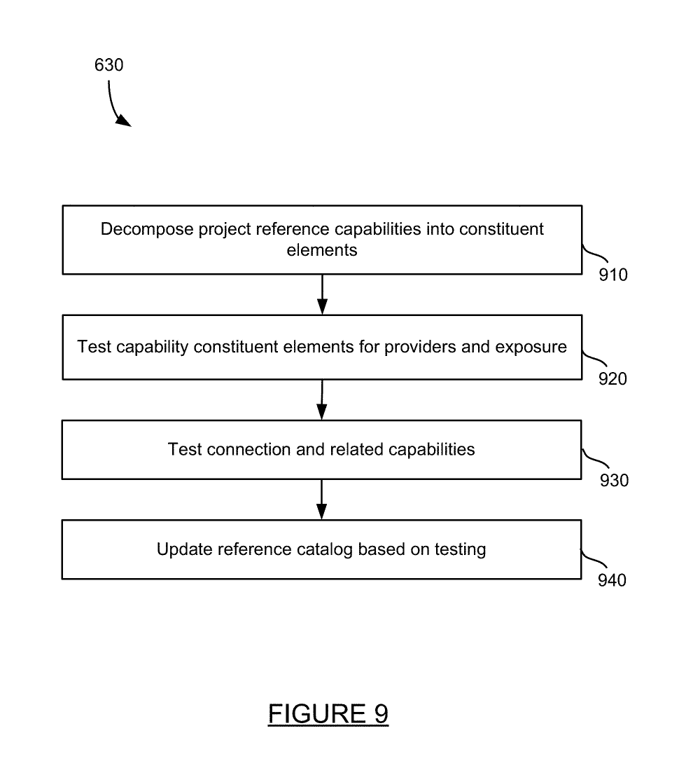

Testing of the designed offer is performed at step 630. Testing a designed offer may include decomposing the reference capabilities into constituent elements and testing those capabilities. If any issues with the offer are found, they may be addressed within the project and the underlying reference capability catalog. Testing of a designed offer is discussed in more detail below with respect to the method of FIG. 9.

FIG. 7 is a method for designing an offer based on a reference capability catalog. The method of FIG. 7 provides more detail for step 610 of the method of FIG. 6. First, a login is performed for a user at step 710. Login process may include receiving a user name and password, comparing the received username and password to that stored for a particular user account, and granting the user access based on whether the login credentials provided by the user match those associated with a particular user account. User permissions are then identified for the user based on the user login credentials at step 720. Within the user's account, permissions may be specified for the user. The permissions may identify which capabilities the user is allowed to access and manipulate while creating an offer.

A project is initialized for the user at step 730. Initializing a project may include creating a new project for receiving input from a user to open and access an existing project. Once a particular project is initialized, reference capability catalogs may be provided to the user based on the user's permission level at step 740. Design module 230 may identify a user's permission level based on the user's account information. Design module 230 may then access reference capability catalogs, or individual capabilities within each catalog, that may be accessed and manipulated by the user based on the user's permission information.

Capabilities from the catalogs may be introduced into the workspace through a user interface by a user at step 750. In some instances, user may drag-and-drop icons or other graphical indicators associated with capabilities into a particular workspace within a user interface. The user may drag capabilities into a virtual workspace, manipulate the capabilities around each other, connect capabilities and form relationships among them, and otherwise configure the reference capabilities. For example, capabilities within a user interface may be associated based on relationships as part of creating an offer at step 760. For example, a user may combine a charge reference capability with a quality of service capability to indicate a particular charge for a particular type of service within an offer.

Once the capabilities are imported into the GUI, the user is provided additional tools to edit the imported information and to create a translation map which may be stored in the user's workspace for further editing or in a database as an operational component. By way of analogy, the reference capabilities catalog serves as a configurable and extensible multi-language dictionary. Initially, this dictionary may contain only one language-the reference capabilities. It is configurable into a multi-language dictionary primarily because the present invention provides a toolset in a GUI for the user to create a capability translation scheme between the user's system of choice and a capability reference catalog. The toolset includes a capability discovery function, which when provided appropriate information, imports the capabilities of the user's system into the GUI, where the user may operate on the imported capabilities. The GUI also provides a function to extend the reference catalog, given that the catalog initially contains only a subset of the universe of capabilities provided by all business, IT, and network systems.

Capability parameters may be modified at step 770. Modifying capability parameters may include modifying values associated with a reference capability, metadata associated with a particular capability, and other data for the capability. For instance, for a charge reference capability, a user may modify a parameter that indicates the particular charge for the offer, such as for example from $15 to $20.

FIG. 8 is a method for performing validation of an offer design. The method of FIG. 8 provides more detail for step 620 of the method of FIG. 6. An approval flow is assigned to an offer at step 810. User may assign an approval flow by indicating the project is complete and requesting that the project be approved. A user may request approval by selected individuals or users, or the approval flow may be predetermined for the user based on the user's account. Once the approval flow is assigned, reviewers to review the offer are notified at step 820. The reviewers may then review the offer and provide feedback or validate the offer.

A design may be validated at step 830. Validation may be performed based on rules, exclusions, and dependencies associated with reference capabilities used to create the offer. For example, compatibility rules may specify whether or how a particular reference capability is compatible with another capability. Exclusion rules may specify values, metadata, or associations that are prohibited for a particular reference capability. Dependencies may indicate what is required to accommodate a particular reference capability. For example, a first reference capability might require a second reference capability in order to be implemented properly within an offer. In this case, anytime the first reference capability is identified, the second reference capability must be added as well.

An approval status is determined for the validation and processed at step 840. Once the approval flow is assigned to an offer, the status might be “pending approval.” If validation of the offer was successful, the status might be changed to “approved.” Approved the validation of the offer is not successful, the status might be changed to “approval rejected.” When validation is not successful, an alert or notification may be sent to a user associated with the offer design that specifies how to modify or correct the reasons causing the failed validation.

FIG. 9 is a method for performing testing of an offer design. The method of FIG. 9 provides more detail for step 630 of the method of FIG. 6. A project reference capability is decomposed into constituent elements at step 910. The constituent elements may include individual objects that compose the project reference capability. The capability constituent elements may then be tested for both providers and exposure at step 920. The providers of a capability constituent element may be tested to confirm they still provide and support the constituent element. The exposure testing may confirm that the constituent element may work on a variety of platforms, such as a mobile device, network browser, client application, and other platforms of exposure.

A connection and related capabilities are tested at step 930. Testing a connection may include confirming that a third-party that originally provides the capability functionality is still providing that functionality. Testing of related capabilities may include testing reference capabilities from a catalog determined to be required to execute a reference capability incorporated into an offer. A reference catalog may then be updated based on the testing at step 940. Updating a reference catalog based on the testing may include modifying one or more reference capabilities based on updated communication with a third-party, the presence or absence of any selected reference capabilities, and other changes made to the reference capability-based on the testing process.

FIG. 10 is a method for providing an offer to a user. The method of FIG. 10 provides more detail for step 330 of the method of FIG. 3. An offer is published to user through exposure platforms at step 1010. Publishing the offer may include providing the offer through a website, providing scripts to call support centers associated with the offer, and providing other collateral supporting information and content that goes with particular offer. Automatic lifecycle management may be performed at step 1020. Lifecycle management may include tracking a time at which the offer is provided, processing and managing backend processes for offers engaged in or purchased by users, and other lifecycle management. Analytics may be performed for the system providing the offer at step 1030. The analytics may include identifying the number of sales, the revenue generated through the sales of the offer, the number of help calls associate with the offer, and other sales and business related metrics associated with providing the offer.

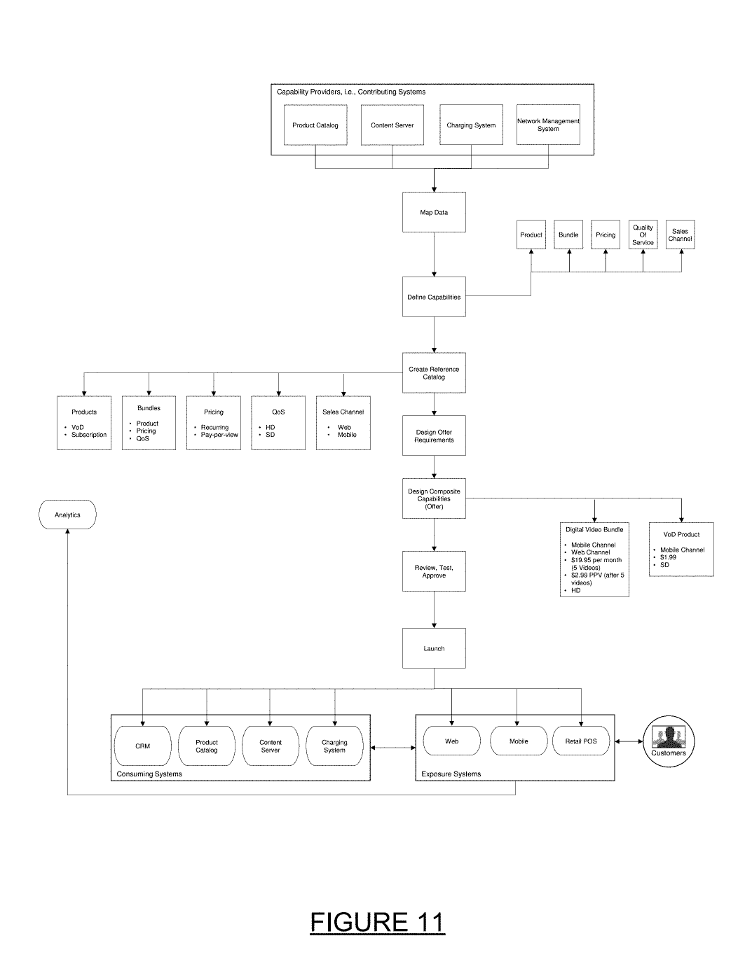

FIG. 11 is a block diagram of the logical flow for creating an offer. As shown in FIG. 11, capability providers of a charging system, content server, and product catalog are configured and data models are retrieved from each capability provider. The retrieve data models are then mapped to a data model template and capabilities are defined from the data model template. The defined capabilities for those providers may include a product, bundle, pricing, quality of service, and sales channel. From those capabilities, a reference capabilities catalog is created. The reference capabilities catalog may include a products capability, bundle capability, pricing capability, quality of service capability, and sales channel capability. Each reference capability may include fields or metadata, such as for example product, pricing, and quality of service for a bundles capability and recurring for pay-per-view for a pricing capability. Composite capabilities may then be designed from the reference to the ability catalog. As illustrated, a digital video bundle composite capability is generated that includes data for mobile channel, web channel, a charge of $19.95 per month for five videos, a pay-per-view charge of $2.99 after five videos, and high definition video. The composite capabilities and reference capabilities catalog is reviewed, tested, approved, and then launched. Launching the offer may include providing the offer through exposure systems of a mobile device and web service, as well as accessing provider systems of charging system, content system, and product catalog that support the reference capabilities.

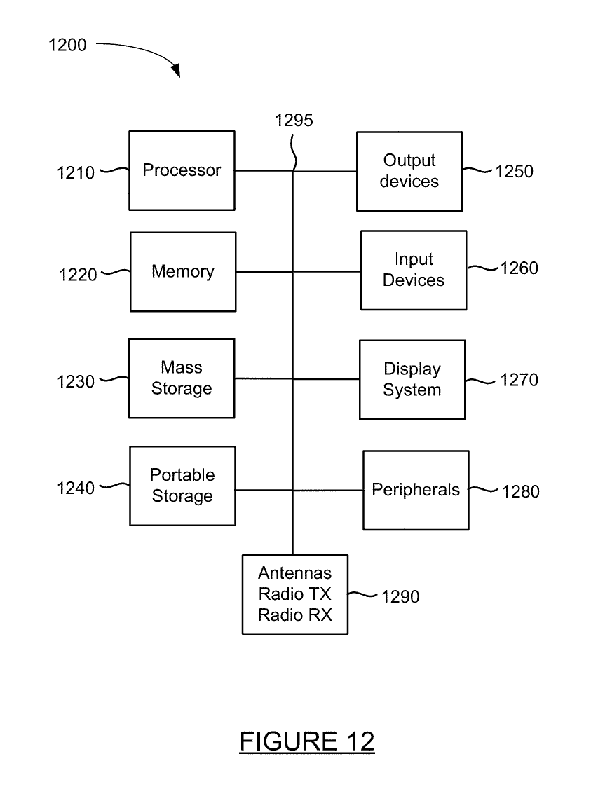

FIG. 12 is a block diagram of an exemplary system for implementing the present technology. System 1200 of FIG. 12 may be implemented in the contexts of the likes of client computer server 150, client devices 160, datastores 155, machines that implement systems 110-140, clients 170, mobile device 180, and client 190. The computing system 1200 of FIG. 12 includes one or more processors 1210 and memory 1220. Main memory 1220 stores, in part, instructions and data for execution by processor 1210. Main memory 1220 can store the executable code when in operation. The system 1200 of FIG. 12 further includes a mass storage device 1230, portable storage medium drive(s) 1240, output devices 1250, user input devices 1260, a graphics display 1270, and peripheral devices 1280.

The components shown in FIG. 12 are depicted as being connected via a single bus 1290. However, the components may be connected through one or more data transport means. For example, processor unit 1210 and main memory 1220 may be connected via a local microprocessor bus, and the mass storage device 1230, peripheral device(s) 1280, portable storage device 1240, and display system 1270 may be connected via one or more input/output (I/O) buses.

Mass storage device 1230, which may be implemented with a magnetic disk drive, an optical disk drive, a flash drive, or other device, is a non-volatile storage device for storing data and instructions for use by processor unit 1210. Mass storage device 1230 can store the system software for implementing embodiments of the present invention for purposes of loading that software into main memory 1220.

Portable storage device 1240 operates in conjunction with a portable non-volatile storage medium, such as a floppy disk, compact disk or Digital video disc, USB drive, memory card or stick, or other portable or removable memory, to input and output data and code to and from the computer system 1200 of FIG. 12. The system software for implementing embodiments of the present invention may be stored on such a portable medium and input to the computer system 1200 via the portable storage device 1240.

Input devices 1260 provide a portion of a user interface. Input devices 1260 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1200 as shown in FIG. 12 includes output devices 1250. Examples of suitable output devices include speakers, printers, network interfaces, and monitors.

Display system 1270 may include a liquid crystal display (LCD) or other suitable display device. Display system 1270 receives textual and graphical information, and processes the information for output to the display device. Display system 1270 may also receive input as a touch-screen.

Peripherals 1280 may include any type of computer support device to add additional functionality to the computer system. For example, peripheral device(s) 1280 may include a modem or a router, printer, and other device.

The system of 1200 may also include, in some implementations, antennas, radio transmitters and radio receivers 1290. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as Bluetooth devices, and other radio frequency networks. The devices may include one or more radio transmitters and receivers for processing signals sent and received using the antennas.

The components contained in the computer system 1200 of FIG. 12 are those typically found in computer systems that may be suitable for use with embodiments of the present invention and are intended to represent a broad category of such computer components that are well known in the art. Thus, the computer system 1200 of FIG. 12 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, C, C++, Node.JS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for creating an offer based on a reference capability catalog, comprising:
defining by a module of one or more modules stored and executed on a server a capabilities catalog, the capabilities catalog based on a plurality of identified capabilities of one or more third party providers remote from the server;
creating, in response to user input received through an interface provided by the server, an offer based on a selected one or more of the capabilities in the catalog; and
providing by a module of one or more modules stored and executed on the server the offer to a user over a network.

2. The method of claim 1, further comprising:
accessing a data model from a third party service provider;
mapping the accessed data model to a data model template; and
defining the capabilities catalog based on the data model template.

3. The method of claim 1, wherein the capabilities catalog includes a composite capability constructed from two or more capabilities in the catalog.

4. The method of claim 1, wherein creating includes associating two or more capabilities from the capability catalog to collectively implement the offer.

5. The method of claim 1, wherein creating includes modifying a parameter of a capability.

6. The method of claim 1, wherein the selected capabilities include a customer experience capability, the customer experience capability incorporated into the offer at the time of design for the offer.

7. The method of claim 1, wherein the capabilities catalog is created and the offer is created and provided by a single application.

8. The method of claim 1, wherein requirements are defined within a project that define the parameters of an offer.

9. The method of claim 1, the method further comprising performing a validation of the offer.

10. The method of claim 1, the method further comprising performing a testing of the offer.

11. The method of claim 1, the method further comprising performing analytics of the offer provided by the server.

12. A non-transitory computer readable storage medium having embodied thereon a program, the program being executable by a processor to perform a method for creating an offer based on a reference capability catalog, the method comprising:
defining a capabilities catalog based on a plurality of identified capabilities of one or more third party providers remote from the server;
defining a set of requirements to create the structure of a future offer;
creating, in response to user input received through an interface, an offer based on a selected one or more of the capabilities in the catalog; and
providing the offer to a user over a network.

13. The non-transitory computer readable storage medium of claim 1, the method further comprising:
accessing a data model from a third party service provider;
mapping the accessed data model to a data model template; and
defining the capabilities catalog based on the data model template.

14. The non-transitory computer readable storage medium of claim 10, wherein the capabilities catalog includes a composite capability constructed from two or more capabilities in the catalog.

15. The non-transitory computer readable storage medium of claim 10, wherein creating includes associating two or more capabilities from the capability catalog to collectively implement the offer.

16. The non-transitory computer readable storage medium of claim 10, wherein creating includes modifying a parameter of a capability.

17. The non-transitory computer readable storage medium of claim 10, wherein the capabilities catalog is created and the offer is created and provided by a single application.

18. The non-transitory computer readable storage medium of claim 10, the method further comprising performing a validation of the offer.

19. The non-transitory computer readable storage medium of claim 10, the method further comprising performing a testing of the offer.

20. The non-transitory computer readable storage medium of claim 10, the method further comprising performing analytics of the offer provided by the server.

21. A system for creating an offer based on a reference capability catalog, comprising:
a server including a memory and a processor; and
one or more modules stored in the memory and executed by the processor to define by the server a capabilities catalog based on a plurality of identified capabilities of one or more third party providers remote from the server, create, in response to user input received through an interface provided by the server, an offer based on a selected one or more of the capabilities in the catalog, and provide by the server the offer to a user over a network.
